(19) United States
(12) Patent Application Publication
(10) Pub. No.: US 2025/0148157 A1
(43) Pub. Date: May 8, 2025

(54) QUANTIFYING ELECTROMAGNETIC HAZARDS FOR LINK PLACEMENT IN A STRUCTURE

(71) Applicant: THE BOEING COMPANY, Arlington, VA (US)

(72) Inventors: Benjamin A. WESTIN, Charleston, SC (US); Terry R. VOGLER, Nagasaki (JP)

(21) Appl. No.: 18/501,968

(22) Filed: Nov. 3, 2023

(51) Int. Cl. G06F 30/20; G06F 30/12; G06F 30/15; G06F 30/18; G06F 119/02

(52) U.S. Cl. CPC G06F 30/20; G06F 30/12; G06F 30/15; G06F 30/18; G06F 2119/02

(57) ABSTRACT

Aspects herein describe performing analysis of electromagnetic effects (EME) on a structure (e.g., a wing of an aircraft) to identify routes for a link that extends along a length of the structure. With metallic links, it is easier to identify safe regions since EME is typically limited to simply simulating the voltage along the fuel line when a harmful EM event occurs, e.g., a lightning strike. However, for non-metallic links, the system can also determine the energy along the link, which depends on the electric field, the voltage potential, and the properties of the link. The potential energy can determine whether, a hazardous EM event could occur. Thus, the aspects herein can apply to both metallic and non-metallic links. After determining the potential energy, the system can output a GUI that indicates to the designer safe zones for routing the link in the structure.

### FIELD

The present disclosure relates generally to determining a route for a link (e.g., a fuel line, conduit, or wire) that is safe from harmful electromagnetic (EM) events in a structure.

### BACKGROUND

Electromagnetic effects (EME) analysis uses computational electromagnetics models to analyze many types of electromagnetic threats to structural products, which is useful in the design, manufacture, and sustainment of these structural products. These threats include radiated and conducted energy due to lightning and other threats, as well as electrostatics. These threats are a concern of many industries such as the aircraft, power generation, and petrochemical industries. Certain structural products in these industries are susceptible to lightning strikes and other electromagnetic threats.

Each EME threat requires a specific model of the same structural-product design, and these models often take months to build. Existing approaches to building EME models typically include a modeler requesting design data from design engineers, and manually converting their interpretation of the data into an EME model. Existing techniques often require multiple iterations to optimize system routing of system wiring, and appropriate computer models can take months to develop. There is also no defined method for balancing EME requirements for system routing wiring and other system elements, and additional “keep-out” zones are only described relative to other features. As a result, verifying that routing meets requirements is typically through visual inspection and by following generalized design guides. As such, any detailed analysis for exceptions or revised requirements can take a long time. Providing consistent and reliable models for designing systems that avoid EME threats remains a challenge.

### SUMMARY

One aspect herein is an apparatus that includes a processor and memory. The memory includes instructions which, when executed on the processor, performs an operation. The operation includes conducting an electromagnetic (EM) simulation of a hazardous EM event using a model of a structure, determining at least one of electric fields and voltage potential in the structure based on the EM simulation, receiving parameters of a link to be installed in the structure, determining potential energy along potential routes for the link in the structure based on the link parameters and the at least one of electric fields and voltage potential, and outputting for display a GUI indicating at least one safe zone for routing the link in the structure.

Another aspect herein is a method that includes conducting an EM simulation of a hazardous EM event using a model of a structure, determining at least one of electric fields and voltage potential in the structure based on the EM simulation, receiving parameters of a link to be installed in the structure, determining potential energy along potential routes for the link in the structure based on the link parameters and the at least one of electric fields and voltage potential, and outputting for display a GUI indicating at least one safe zone for routing the link in the structure.

Another aspect herein is a non-transitory computer readable storage medium having program instructions embodied therewith, the program instructions executable by a processor to perform an operation. The operation includes conducting an EM simulation of a hazardous EM event using a model of a structure, determining at least one of electric fields and voltage potential in the structure based on the EM simulation, receiving parameters of a link to be installed in the structure, determining potential energy along potential routes for the link in the structure based on the link parameters and the at least one of electric fields and voltage potential, and outputting for display a GUI indicating at least one safe zone for routing the link in the structure.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 illustrates an aircraft, according to aspects of the present disclosure.

FIG. 2 is a computing system for identifying safe routes for a link in a structure, according to aspects of the present disclosure.

FIG. 3 is flowchart for identifying regions in a structure that are safe from EM events, according to aspects of the present disclosure.

FIG. 4 is a 1D model of an aircraft wing, according to aspects of the present disclosure.

FIG. 5 is a 2D model of an aircraft wing, according to aspects of the present disclosure.

FIG. 6 is a 3D model of an aircraft wing, according to aspects of the present disclosure.

FIG. 7 is a graphical user interface (GUI) for indicating safe regions for routing a link in a wing of an aircraft, according to aspects of the present disclosure.

FIG. 8 is a flowchart for optimizing the route of a link in a structure, according to aspects of the present disclosure.

FIG. 9 is a GUI for indicating safe regions for routing a link in a wing of an aircraft, according to aspects of the present disclosure.

### DETAILED DESCRIPTION

Aspects herein describe performing analysis of EME on a structure (e.g., a wing of an aircraft) to identify routes for a link that extends along a length of the structure. While the discussion below primarily discusses applying the aspects herein to a fuel line, they can be applied to any type of link (e.g., tube, conduit, or electrical wire). With metallic fuel lines, it is easier to identify safe regions since EME is typically limited to simply simulating the voltage along the fuel line when a harmful EM event occurs, e.g., a lightning strike. However, for non-metallic links—e.g., composite fuel lines—the system also determines the energy along the link, which depends on the electric field, the voltage potential, and the properties of the link (e.g., the material of the link, diameter of the link, resistance values, and the like). The potential energy can determine whether, e.g., a spark between the non-metallic link and another component could occur which could result in a hazardous situation. Thus, the aspects herein can apply to both metallic and non-metallic conducting materials that are used for the links (e.g., links with both high and low electrical conductivity).

After determining the potential energy, the system can output a GUI that indicates to the designer safe zones (or conversely keep-out zones) for routing the link in the structure. The designer can use their judgement to then decide where in the safe zone to place the link based on other factors such as ease of installation, distance to access ports, etc. In one aspect, the system can go further than simply indicating safe zones and keep out zones and suggest an optimized route for the link to the designer. This optimization can perform tradeoffs between ease of installation, routes to avoid, and preferential routes.

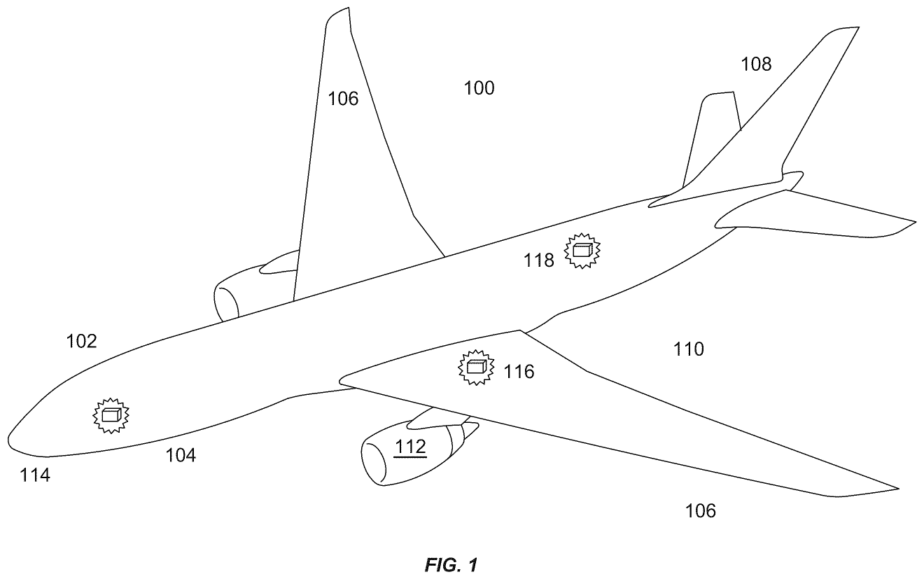

FIG. 1 illustrates an aircraft 100 according to one example aspect. The aircraft 100 includes an airframe 102 with a fuselage 104, wings 106, and tail 108. The aircraft also includes a plurality of high-level airplane functional systems 110 such as a propulsion system. In some examples, the propulsion system includes two wing-mounted engines 112. In other aspects, the propulsion system may include other arrangements, for example, engines carried by other portions of the aircraft including the fuselage and/or the tail. The high-level systems may also include an electrical system 114, hydraulic system 116 and/or environmental system 118. Any number of other systems which provide for the operation and flight of the aircraft 100 may be included.

While the aspects herein are discussed in the context of an aircraft 100, they can be applied to any structure which might be susceptible to hazardous EM events (e.g., excessive radiation, lightning strikes, static electricity, etc.) such as tall buildings, spacecraft, satellites, refineries, and the like.

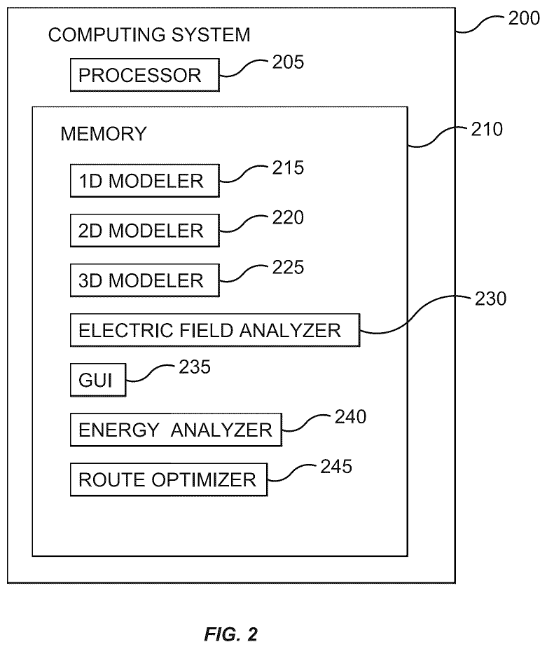

FIG. 2 is a computing system 200 for identifying safe routes for a link in a structure, according to aspects of the present disclosure. The computing system 200 can be a single computing device (e.g., a server or laptop) or a plurality of computing devices (e.g., a data center or cloud computing environment). The computing system 200 includes a processor 205 which represents any number of processing elements (e.g., one or more central processing units (CPUs)) with any number of processing cores. The computing system 200 also includes memory 210 which can be nonvolatile memory, volatile memory, and combinations thereof.

The memory 210 includes various software applications and constructs. In this example, the memory 210 includes a 1D modeler 215 that provides a 1D model of a structure (e.g., a portion of an aircraft, building, spacecraft, etc.), a 2D modeler 220 that provides a 2D model of the structure, and a 3D modeler 225 that provides a 3D model of the structure. In one aspect, the 1D modeler 215, 2D modeler 220, and 3D modeler 225 model the same portion of the structure (e.g., the wing of an aircraft).

The memory 210 also includes an electric field analyzer 230 that determines the electric field in the 1D/2D/3D models generated by the 1D modeler 215, 2D modeler 220, and the 3D modeler 225 in the presence of a hazardous EM event (e.g., a lightning strike or electrostatics). The electric field analyzer 230 can also determine the voltage potential within those models during the hazardous EM event.

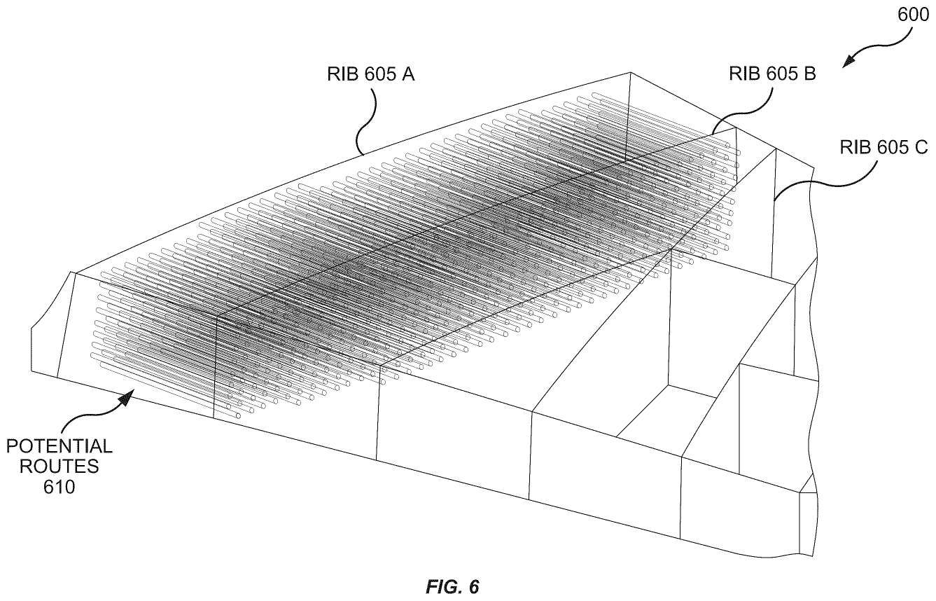

In one aspect, the electric field analyzer 230 determines the electric field and voltages along a number of potential routes of the link through the structure. These potential routes can also be referred to as probes. For example, the routes may extend between ribs of the aircraft (which will be discussed in more detail in FIG. 6).

The memory 210 also includes a GUI 235 which represents any number of GUIs that can be displayed to the user. The GUI 235 can be used to provide output to a user (e.g., a designer) and to get input from the user. For example, the user can use the GUI 235 to provide parameters of the link that will be run inside the structure such as the material of the link, the diameter of the link, the resistivity on the link, etc.

The memory 210 also includes an energy analyzer 240 that determines the energy generated along potential routes of the link in the structure in the presence of the hazardous EM event. Determining the energy along the potential routes of the link can be especially useful for links that are non-metallic. That is, while the electric fields and voltage determined by the electric field analyzer 230 may be sufficient to determine whether electrical protections should be used with metallic tubes, for non-metal, composite links, the energy on the link determines whether a spark will occur that can result in a hazardous situation. That is, for metallic links, in one aspect, only the voltage is determined by the system since the voltage determines whether a spark will occur. However, with composite material, the energy on the surface of the link determines whether a spark occurs. Energy is determined by the current and voltage in the material of the link. In one aspect, the composite material contains a plastic resin embedded with either conductive carbon filaments or non-conductive glass filaments. The aspects described herein are especially useful for non-metal materials (like composite materials) where the charge distribution and dissipation upon an arc discharge event is less than immediate, because of the lower conductivity of the overall system element.

The memory 240 also includes a route optimizer 245 that can evaluate the results generated by the energy analyzer 240 and identify safe zones or keep out zones for routing the link. These zones can be displayed in one of the GUIs 235.

In another aspect, the route optimizer 245 suggest a preferred route, rather than simply displaying safe and unsafe zones in the structure. For example, the route optimizer 245 may consider factors such as ease of installation, accessibility to access ports, congestion, and the like to determine a route for the link. Once determined, the route optimizer 245 can output the preferred route in the GUI 235.

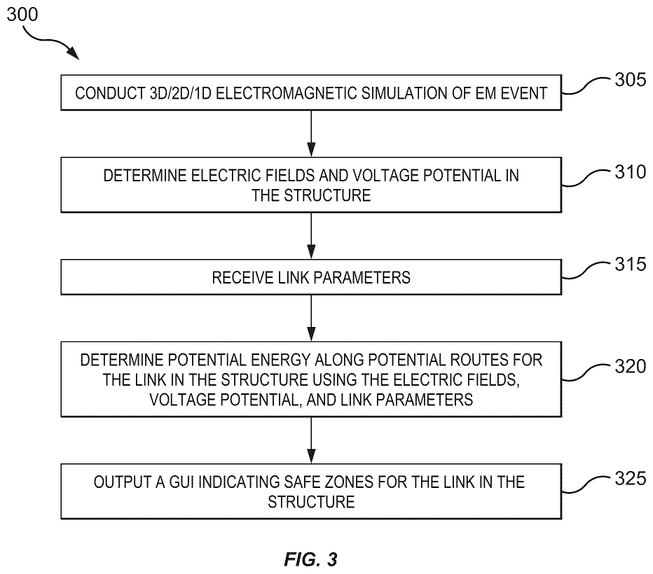

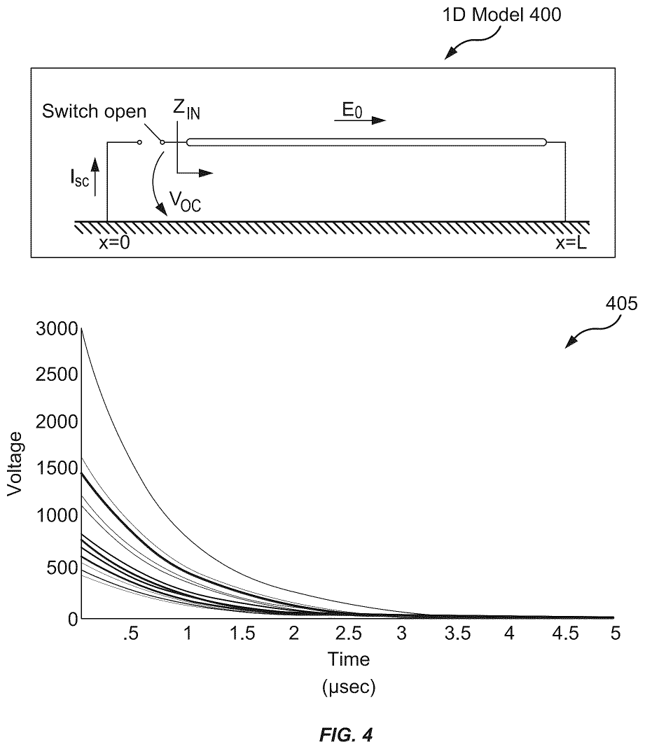

FIG. 3 is flowchart of a method 300 for identifying regions in a structure that are safe from EM events, according to aspects of the present disclosure. At block 305, the 1D modeler 215, the 2D modeler 220, and the 3D modeler 225 conduct 3D/2D/1D electromagnetic simulation in the presence of a hazardous EM event (e.g., a lightning strike) within their respective models of the structure. For example, the 1D modeler 215 can simulate the effect of a lightning strike on a 1D model of a wing of an aircraft, while the 2D modeler 220 simulates the effect of a lightning strike on a 2D model of the wing of the aircraft and the 3D modeler 225 simulates the effect of a lightning strike on a 3D model of the wing of the aircraft. Exemplary 1D, 2D, and 3D models are illustrated in FIGS. 4-6.

Moreover, while the method 300 discusses using 1D, 2D, and 3D models, this is not a requirement. The method 300 could use just 2D or 3D models, or just a 2D model, or only a 3D model. While this can determine safe zones for routing the link, it may not be as accurate as using all three modelers, but it might use less compute power or provide results in a shorter amount of time.

FIG. 4 is a 1D model 400 of an aircraft wing, according to aspects of the present disclosure. FIG. 4 illustrates that the aircraft wing can be modeled using the illustrated variables where closing the switch simulates an EM event along the length (L) of the wing. In one aspect, the 1D model 400 is based on a transmission line equation. The 1D model 400 can be used by the 1D modeler discussed above.

The chart 405 illustrates plots that correspond to different points or locations within the structure. For example, the chart 405 illustrates the voltage at these points over a period of time when a lighting strike occurs. These points can correspond to different locations within a cross section of the structure (e.g., a cross section of the wing).

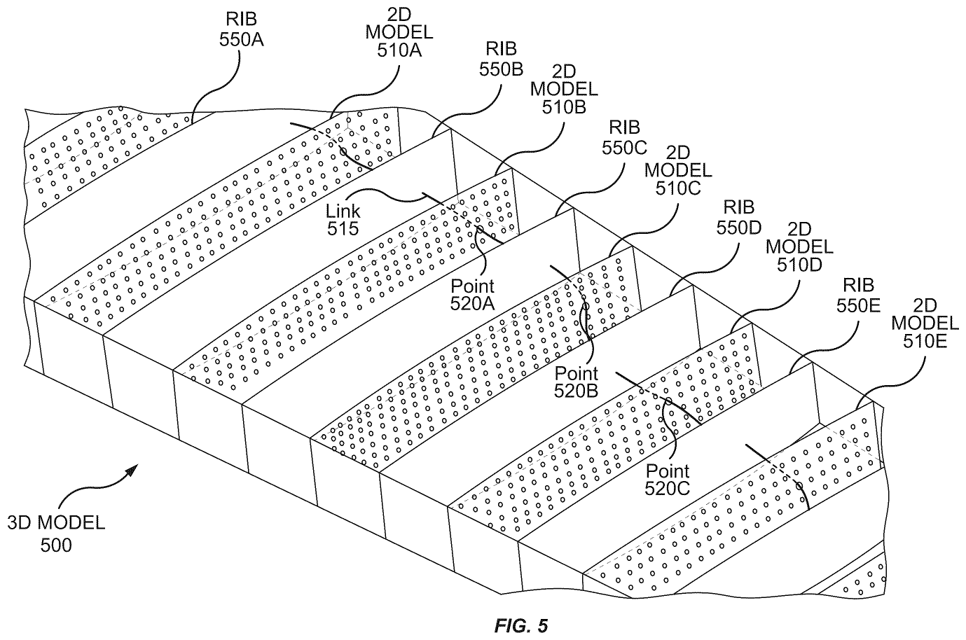

FIG. 5 illustrates 2D models 510 taken from a 3D model 500 of an aircraft wing, according to aspects of the present disclosure. One of the 2D models 510 can be used by the 2D modeler discussed above. In this example, the aircraft wing includes ribs 505 that provide structural support from the outer surface of the wing. For ease of explanation, the top surface of the wing is removed so that the internal structure of the wing is viewable in FIG. 5.

In this example, the 2D models 510 are cross sections of the 3D model 500. Specifically, the 2D models 510 are cross sections of the wing between the ribs 505. The 2D models 510 can be a slice or cut of the design geometry of the structure (a wing in this example).

FIG. 5 also illustrates a link 515 (e.g., a fuel line, hydraulic line, tube, wire, or conduit) that extends along the length of the wing. The link 515 can be a single link that passes through apertures in each of the ribs 505. However, it may be easier to install the link 515 if it is formed using segments. For example, although not shown, the wing can include access hatches between each of the ribs so that the space between a pair of each of the ribs 505 is accessible. After determining where to route the link 515, a technician can connect one link segment between each pair of the ribs 505. The ribs 505 can have apertures so that the link segments can be connected to form the link 515 that functions as if the link 515 was one continuous link. This way, the technician does not have to run one continuous link through each of the ribs which may be difficult if the route bends or curves and the link is made from an inflexible material (e.g., metal or carbon fiber). However, the link segments could be custom made to fit between each of the ribs 505.

In one aspect, the techniques described herein can determine whether to make the link 515 a single link, or form the link 515 using segments that extend between respective pairs of ribs 505. Each rib 505 is a possible grounding point for a link 515, to limit the overall length along which electric potential is coupled onto the link. In practice, at least for traditional metal tube configurations, the designers pass through a few consecutive ribs 515 until the model says that the link should be grounded, as passing through any more bays would exceed the allowable potential for safety reasons. That is, longer runs result in higher accumulated voltage. Adding grounds is an alternative to rerouting. For non-metal tubes, the link length helps determine which calculation form is used for the electrical parameters (voltage, current, energy) because these links 515 have more complex equations which tend towards “long-link” asymptotes and “short-link” asymptotes.

FIG. 5 also illustrates points 520 where the link 515 passes through the 2D models 510. FIG. 5 also illustrates that each 2D model 510 can have a plurality of points (e.g., a grid). These points can be where the 2D modeler conducts the simulation to determine the effect of the hazardous EM event on the structure.

FIG. 6 is a 3D model 600 of an aircraft wing, according to aspects of the present disclosure. For example, the 3D model 600 may be used by the 3D modeler discussed above. The 3D model 600 includes ribs 605 which are used to provide structure support to the outer surface of the wing.

FIG. 6 illustrates potential routes 610 for the link. These potential routes 610 (also referred to as probes) extend between the ribs 605. In one aspect, at block 305, the 3D modeler performs the EM simulation on the potential routes 610. That is, the 3D modeler determines the affect a hazardous EM event has along the length of the potential routes 610.

Returning to the method 300, at block 310, the electric field analyzer (e.g., the electric field analyzer 230 in FIG. 2) determines electric fields and voltage potential in the structure using the EM simulations performed at block 305. For example, the electric field analyzer can determine the electric field and voltage potential along the length of the 1D model shown in FIG. 4. For the 2D model, the electric field analyzer may determine the electric field and voltage potential at each of the points 520 in a 2D slice or cross section of the structure as shown in FIG. 5. For the 3D model, the electric field analyzer may determine the electric field and voltage potential at each of the potential routes 610 illustrated in FIG. 6.

While performing the blocks 305-310 may be sufficient for metallic links, it might not be for non-metallic links. For example, for metallic links, knowing the electric field and voltage at the locations discussed above can indicate the risk of a spark from the link to another component in the structure. However, for non-metallic links, this information might not be sufficient since the energy at the locations determines whether a spark occurs.

At block 315, a GUI receives parameters of the link to be installed in the structure from a user (e.g., the designer). In one aspect, the GUI might include fields for the user to specific a material of the link (e.g., what type of composite it is, whether it is metallic, etc.), the diameter of the link, whether it is annular or solid, the resistivity of the material, and the like.

At block 320, an energy analyzer (e.g., the energy analyzer 240 in FIG. 2) determines potential energy along potential routes for the link using the electric fields, voltage potential, and link parameters. Put differently, the energy analyzer determines the energy generated at various points or routes in the structure in the presence of the hazardous EM event. The energy analyzer can also compare the energy at the locations to one or more threshold to determine the likelihood the energy would cause a hazardous condition (e.g., a spark).

At block 325, the system outputs for display a GUI indicating safe zones for the link in the structure. A designer can then use the displayed GUI to determine where to place the link in the structure. By placing the link in a safe zone of the structure, when a real hazardous EM event occurs, the link will not cause a hazardous condition (e.g., a spark).

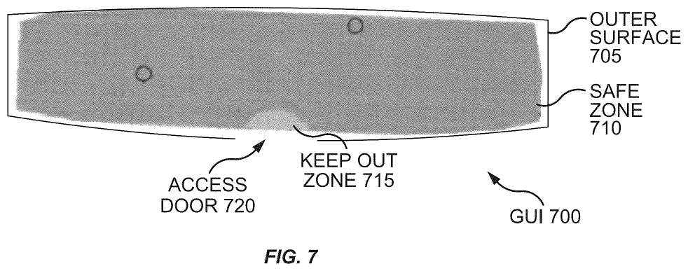

FIG. 7 is a GUI 700 for indicating safe regions for routing a link in a wing of an aircraft, according to aspects of the present disclosure. The GUI 700 can be displayed on a device—e.g., a monitor, tablet, laptop screen, etc. In this example, the GUI 700 indicates a safe zone 710 within an outer surface 705 of the structure (e.g., an aircraft wing) where the link can be routed. If the designer places the link in the safe zone 710, the hazardous EM event (e.g., a lightning strike) will not create enough energy on the link to create a hazardous condition (e.g., a spark).

In this example, the GUI 700 also indicates a keep out zone 715. In this instance, the keep out zone 715 is in close proximity to an access door 720 of the structure. The keep out zone 715 may indicate a region where if the link was placed, there is an unacceptable chance that the hazardous EM event might create the hazardous condition. The designer may want the link to be near the access door 720 since that means it would be easier to install the link; however, that is the keep out zone 715. By precisely knowing the boundary between the keep out zone 715 and the safe zone 710, the designer knows how far the link should be from the access door 720 before it is in the safe zone 710. This is an advantage compared to previous techniques where this level of precision was not known. The aspects herein can provide an accurate location of the safe zone 710, which might be only a tens of centimeters from the access door 720, and thus, still easily accessible by the person tasked with installing the link. Previous technique may have erred on the side of caution since they were not reliable and made the keep out region much larger than it needs to be, which makes installation much harder due to complying with confined space entry requirements and also physically limiting spaces where the human body cannot fit.

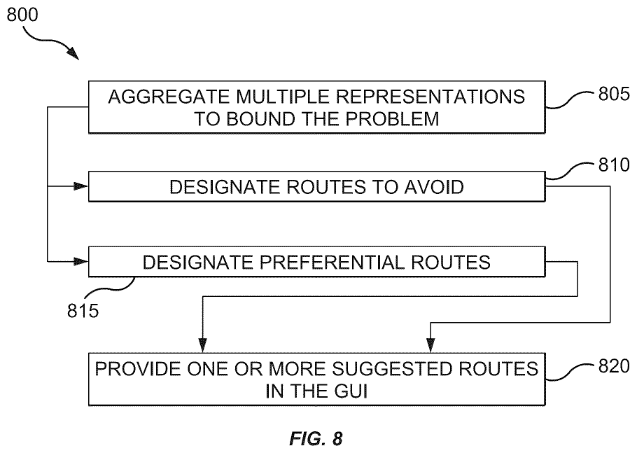

FIG. 8 is a flowchart of a method 800 for optimizing the route of a link in a structure, according to aspects of the present disclosure. In one aspect, the method 800 may begin after block 320 where the energy analyzer has determined the energy at various potential routes for the link.

At block 805, a route optimizer (e.g., the route optimizer 245 in FIG. 2) aggregates multiple representations to bind the problem of identifying safe zones and keep out zones. This aggregation can be based on structural apertures (e.g., holes in the ribs that can attach to segments of the links), the 1D/2D/3D models, energy asymptotes, and lightning strike locations. In one aspect, aggregation searches for the worst case scenario of the 1D/2D/3D models.

The method 800 can perform blocks 810 and 815 in parallel using the aggregated data generated at block 805. At block 810, the route optimizer designates routes to avoid. These routes might be located in the keep out region. Or the routes may be at positions that are far away from the structural apertures that make connecting segments of the link together easier. The routes may also be close to where lightning is likely to strike the structure.

At block 815, the route optimizer designates preferential routes. These routes may be close to the structural apertures, or far away from where lightning is expected to strike. The system may consider a balance of these factors. For example, a preferred route may have a higher probability of a lightning strike (although still in a safe zone) but be near an access door or structural apertures that would make installation much easier.

At block 820, the route optimizer provides one or more suggested routes in the GUI. The system may perform a tradeoff analysis between the routes to avoid and the preferred routes to see which ones to suggest to a designer. In one aspect, the system may present several suggested routes to the designer (e.g., route A (most preferred) and route B (less preferred)).

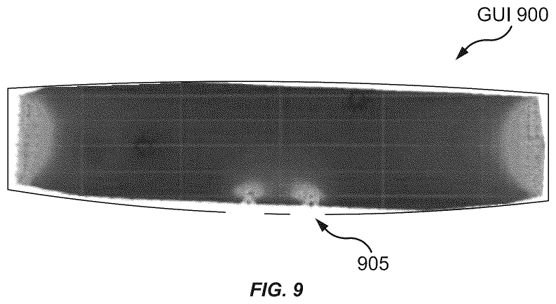

FIG. 9 is a GUI 900 for indicating safe regions for routing a link in a wing of an aircraft, according to aspects of the present disclosure. In this example, the safe regions can be shown as a gradient. That is, the GUI 900 can display a range of safe to unsafe. For example, red (or similar colors) could be used to represent keep out regions while blue/yellow/green could represent safe regions. However, yellow could represent safe regions where there is low risk of a hazardous event, green could represent safe regions where there is very low risk of a hazardous event, and blue could represent safe regions where this is exceptionally low risk of a hazardous event. Thus, although these gradients could all be “safe” since they satisfy a minimum threshold of risk, showing a gradient can help the designer to be extra cautious. For example, there may be a low risk area and very low risk area that are both equally accessible to an access door 905 of the wing. By viewing the GUI 900, the designer can choose to install the link in the very low risk area since it reduces risk of the hazardous event occurring without making it any more difficult to install the link.

Further, the information used to generate the gradients in the GUI 900 can also be used in the blocks in the method 800. For example, the system may consider the various probabilities of the hazardous event occurring as shown in FIG. 9 to provide the suggested routes. As an example, the system can use the gradients represented in FIG. 9 to choose between two routes that are both near the access door 905 but one is in a region that has a smaller risk of the hazardous event occurring.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. An apparatus comprising:
a processor; and
a memory comprising instructions which, when executed on the processor, performs an operation, the operation comprising:
conducting an electromagnetic (EM) simulation of a hazardous EM event using a model of a structure;
determining at least one of electric fields and voltage potential in the structure based on the EM simulation;
receiving parameters of a link to be installed in the structure;
determining potential energy along potential routes for the link in the structure based on the link parameters and the at least one of electric fields and voltage potential; and
outputting for display a graphical user interface (GUI) indicating at least one safe zone for routing the link in the structure.

2. The apparatus of claim 1, wherein the link parameters comprises a material of the link and a diameter of the link.

3. The apparatus of claim 2, wherein the material of the link is a non-metallic composite.

4. The apparatus of claim 1, wherein the safe zone indicates a region where the link will not create a spark during the hazardous EM event.

5. The apparatus of claim 4, wherein the link is a composite fuel line and the structure is a wing of an aircraft.

6. The apparatus of claim 5, wherein the hazardous EM event comprises a lightning strike on the aircraft.

7. The apparatus of claim 1, wherein conducting the EM simulation comprises:
conducting the EM simulation of the hazardous EM event on a 1D model of the structure;
conducting the EM simulation of the hazardous EM event on a 2D model of the structure; and
conducting the EM simulation of the hazardous EM event on a 3D model of the structure.

8. The apparatus of claim 1, wherein operation further comprises, before outputting for display a GUI:
aggregating multiple representations to bound a problem of identifying safe zones and keep out zones for the link;
designating routes for the link to avoid; and
designating routes for the link that are preferred, wherein the GUI displays a least of suggested route for the link.

9. A method, comprising:
conducting an electromagnetic (EM) simulation of a hazardous EM event using a model of a structure;
determining at least one of electric fields and voltage potential in the structure based on the EM simulation;
receiving parameters of a link to be installed in the structure;
determining potential energy along potential routes for the link in the structure based on the link parameters and the at least one of electric fields and voltage potential; and
outputting for display a GUI indicating at least one safe zone for routing the link in the structure.

10. The method of claim 9, wherein the link parameters comprises a material of the link and a diameter of the link.

11. The method of claim 10, wherein the material of the link is a non-metallic composite.

12. The method of claim 9 wherein the safe zone indicates a region where the link will not create a spark during the hazardous EM event.

13. The method of claim 12, wherein the link is a composite fuel line and the structure is a wing of an aircraft.

14. The method of claim 13, wherein the hazardous EM event comprises a lightning strike on the aircraft.

15. The method of claim 9, wherein conducting the EM simulation comprises:
conducting the EM simulation of the hazardous EM event on a 1D model of the structure;
conducting the EM simulation of the hazardous EM event on a 2D model of the structure; and
conducting the EM simulation of the hazardous EM event on a 3D model of the structure.

16. A non-transitory computer readable storage medium having program instructions embodied therewith, the program instructions executable by a processor to perform an operation comprising:
conducting an electromagnetic (EM) simulation of a hazardous EM event using a model of a structure;
determining at least one of electric fields and voltage potential in the structure based on the EM simulation;
receiving parameters of a link to be installed in the structure;
determining potential energy along potential routes for the link in the structure based on the link parameters and the at least one of electric fields and voltage potential; and
outputting for display a GUI indicating at least one safe zone for routing the link in the structure.

17. The computer readable storage medium of claim 16, wherein the link parameters comprises a material of the link and a diameter of the link.

18. The computer readable storage medium of claim 17, wherein the material of the link is a non-metallic composite.

19. The computer readable storage medium of claim 16, wherein the safe zone indicates a region where the link will not create a spark during the hazardous EM event.

20. The computer readable storage medium of claim 19, wherein the link is a composite fuel line and the structure is a wing of an aircraft.
